(19) United States
(12) Patent Application Publication
(10) Pub. No.: US 2002/0018702 A1
(43) Pub. Date: Feb. 14, 2002

(54) Bale feeder

(76) Inventors: Robert P. Stredwick, Bozeman, MT (US); Samuel DeBoer, Manhattan, MT (US); Edward K. McCauley, Boulder, MT (US)

Correspondence Address: Berne S. Broadbent, KIRTON & McCONKIE, 1800 Eagle Gate Tower, 60 East South Temple, Salt Lake City, UT, 84111, US

(21) Appl. No.: 09/764,518

(22) Filed: Jan. 18, 2001

Related U.S. Application Data
(60) Provisional application No. 60/177,088, filed on Jan. 20, 2000.

(51) Int. Cl. B65G 1/00

(52) U.S. Cl. 414/111

(57) ABSTRACT

A round bale feeder is disclosed that includes a series of cylindrical rollers mounted to a support frame and positioned in a V-shape. The rollers are oriented to allow a round bale to rotate thereon and disperse the outer layer of the bale as it rotates. The rollers are operated by a drive mechanism coupled to the ends of the rollers one a common side. The drive mechanism is protected from exposure and environmental factors. The rollers also allow the complete load of the bale to be carried on bearings thereby increasing mechanical efficiency and reliability. Certain embodiments also comprise a bale loader integrated with the feeder apparatus.

### 1. RELATED APPLICATION

The present patent application is related to and claims priority to Provisional Patent Application No. 60/177,088, filed Jan. 20, 2000, which is incorporated by reference for all purposes.

### 2. BACKGROUND

Embodiments of the present invention relate to hay bale feeders which are used to dispense hay, straw and similarmaterials for consumption. More particularly, embodiments of the present invention relate to an improved feeder for feeding out hay, straw and similar materials from round bales.

Round bales are formed by rolling the hay or other material, into a substantially cylindrical shape. These bales may have a diameter of two meters or more. Round bales may be formed using many types of machinery and they typically vary in density and compactness depending on the condition of the material being baled and the type of machine used for baling.

Round bales are fed out by unrolling the bales or by otherwise breaking down the bales into a mat of feed that is dispensed from a trailer or other agricultural equipment. Known machines for feeding hay from a round bale or for unrolling round bales are overly complex, expensive and incapable of feeding hay evenly from round bales of varying density and size.

One known apparatus described in U.S. Pat. No. 4,545,716 uses multiple chains to support angle iron slats which support the bales. The chains are further supported by guide plates. Most feeders use some form of chain and slat mechanism to rotate the bale and to help feed the bale into a chopping, flailing mechanism. The use of chains and slats to rotate a bale or move a bale creates a high maintenance situation. The slats become bent causing chain misalignment where the chain no longer stays in position forcing the operator to stop the feeding operation and relocate the chain on the sprocket. Exposed chain mechanisms are also highly susceptible to rust and corrosion which causes chains to develop excessive friction, buckle and even break. Chains also produce undue friction as they rub against supporting guide plates under heavy loads. Excessive friction in the feeder drive mechanism which commonly develops in chain mechanisms causes increased power requirements, increased stress on components, extended downtime and higher maintenance costs.

### SUMMARY AND OBJECTS OF THE INVENTION

A preferred embodiment of the present invention comprises a bale feeder adapted to feed out round bales of hay, straw and similar material. This apparatus may be constructed integral with some form of motorized agricultural equipment or it may be constructed as a trailer-type device serving as a support frame that is pulled behind or otherwise transported by other equipment.

Preferred embodiments comprise a series of substantially parallel rollers disposed in a V-shaped orientation on the support frame such that a round bale may be supported by the rollers in the notch of the V. End barriers may be located at each end of the rollers to prevent the bales from sliding longitudinally along the rollers. End plates or supports are located at each end of the rollers to support the rollers and their drive mechanism. Generally, bearings are placed in these end plates in which the rollers and some drive elements may rotate. The use of these end supports with bearings and the rollers allows the entire drive mechanism and the rollers to be supported by low-friction, low-maintenance bearings eliminating the problems and inefficiency of the prior art.

Preferably, a plurality of rollers will be disposed on each side of the V-shape so that their longitudinal axes are substantially parallel. The axis of each roller is progressively lower toward the center of the apparatus thereby forming the V-shape.

Gears or pulleys may be located at one or both ends of the rollers, preferably within or adjacent to the end plates or supports. A drive belt or chain may be used to connect the pulleys to a power source such as a hydraulic motor, electric motor, internal combustion engine or power take-off shaft. In this configuration, the drive chain or belt may be located in a housing or cover attached to one of the end supports or plates. In this manner, the drive mechanism with its belt or chain and pulleys or gears may be protected from environmental factors and impacts. This roller configuration also eliminates the friction and alignment problems associated with chains which support the weight of the bale by grinding against guide plates and which are exposed to environmental factors such as humidity and UV rays as well as impact and wear during use.

The rollers themselves may have a solid surface, corrugated surface, mesh surface, a slatted configuration or some other construction that provides sufficient surface area and load engagement. The roller surface area must be sufficient to support the bales without excessive deformation of the bale. The rollers must also provide sufficient engagement with the bale to cause rotation of the bale within the V-shape and dispersion of the bale material.

During use, the rollers are driven in the same direction of rotation so as to cause a round bale to rotate thereon. The V-shape is so configured that the bale will roll on the rollers without substantial transverse motion. In this manner the round bale rotated on the rollers without moving or rolling off the apparatus. As the bale rolls, the outer layer of the bale is “unrolled” or otherwise separated from the bale and distributed onto the ground beside the apparatus. This process continues until a roll is depleted, then another bale is loaded and fed out.

Preferred embodiments of the present invention also comprise a loading apparatus for placing bales onto the rollers. This loading apparatus typically comprises arms which extend outwardly from the feeder to engage a bale. The arms may extend under the bale or into the material of the bale so long as they develop sufficient engagement to lift the bale without tearing or undue distortion. These arms are configured to pivot thereby positioning the bale on the rollers. A hydraulic cylinder or other mechanism may be used to cause the loading mechanism to pivot and relocate the bale.

Accordingly, it is an object of some embodiments of the present invention to provide an improved method and apparatus to support, rotate and feed a round bale.

It is another object of some embodiments of the present invention to provide a round bale feeder with greater reliability and decreased maintenance cost.

It is a further object of some embodiments of the present invention to provide a round bale feeder without friction between chains and guide plates.

It is another object of some embodiments of the present invention to provide a round bale feeder with an integrated bale loader.

These and other objects and features of the present invention will become more fully apparent from the following, description and appended claims, or may be learned by the practice of the invention as set forth hereinafter.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 illustrates a bale feeder in accordance with the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

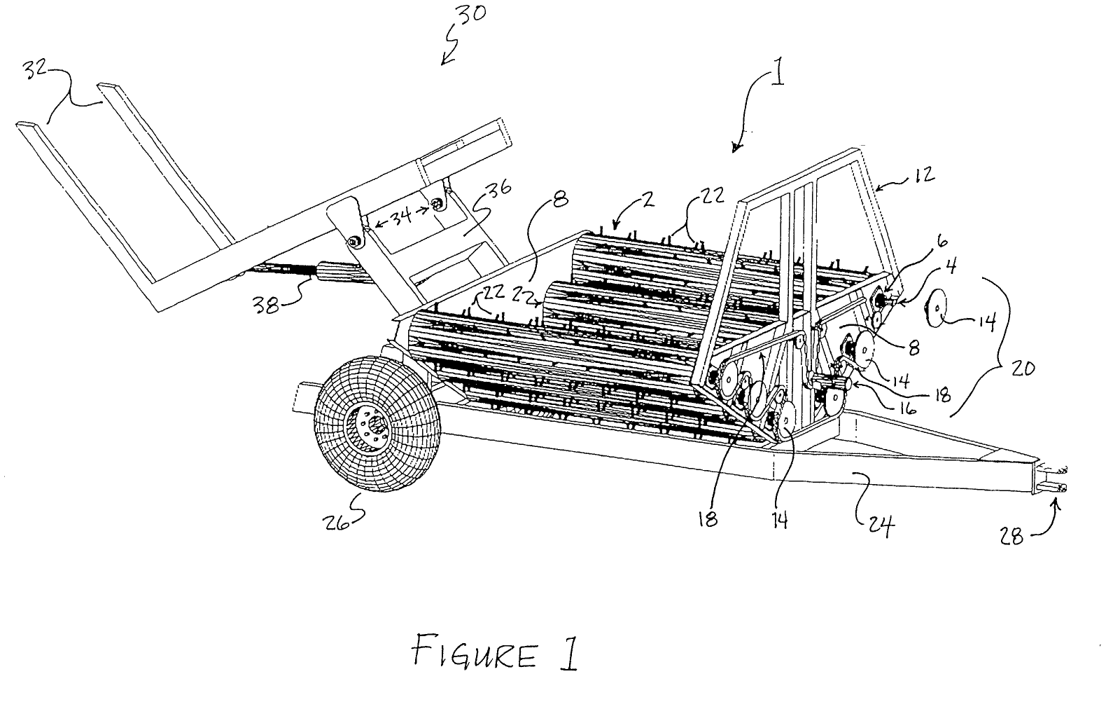

In reference to FIG. 1, a preferred embodiment of the present invention comprises a round bale feeder having a plurality of substantially cylindrically shaped rollers 2. These rollers are arranged so that their axes are parallel and so that their axes are progressively lower in elevation toward the center of the arrangement thereby forming a V-shape therein.

The precise position of the rollers may vary to obtain optimal results for bales of varying size and composition. However, a V-shape having an interior angle of between about 90 degrees and about 150 degrees will generally perform well with typical hay and straw bales. Rollers 2 generally comprise axial shafts 4 which extend through bearings 6 in end supports or plates 8.

These end supports or plates 8 are located at each end of rollers 2 to provide support. End supports or plates 8 may be shaped so as to confine a bale on rollers 2 so that it does not travel longitudinally along rollers 2 and fall off feeder 1. Other retainers 12 may also be used to restrict movement of a bale on feeder 1.

Gears or pulleys 14 are connected to the rollers 2, typically with axial shafts 4 so that rollers 2 may be rotated by mechanical methods. Gears or pulleys 14 are connected to a drive source 16 with belts or chains 18 so that rollers 2 may be rotated. Drive source 16 may be a hydraulic motor, electric motor, internal-combustion engine, power take-off shaft connection or some other means of providing torque and power. Belt or chain 18 is connected to gears or pulleys 14 so that rollers 2 will rotate in the same rotational direction. This configuration will cause a round bale to rotate on rollers 2 without substantial lateral movement thereby allowing access to its outer layer for dispersion.

The drive mechanism 20, comprising the belts or chains 18, gears or pulleys 14, bearings 6, drive source 16 and associated elements is located adjacent to end support or plate 8 so that end plate 8 and extensions thereof may act to protect drive mechanism 20 from environmental factors, wear and impact.

Rollers 2 further comprise bale engagement devices 22 which engage a bale and cause rotation thereof when rollers 2 are rotating. Bale engagement devices 22 may be spikes, bars, hooks or other devices which protrude from rollers 2 and extend into the outer layer of a bale. Engagement devices 22 serve to cause rotation of a bale as well as aid in dispersing the outer layer of a bale as it is rotated on rollers 2.

End supports or plates 8 are typically connected to a frame 24 which may be supported on wheels 26, tracks, skids or other supports which allow transportation thereof. Frame 24 may also comprise a hitch 28 for connection to a tractor or similar vehicle. Feeder 1 may also be a self-propelled apparatus with its own propulsion source.

Preferred embodiments of the present invention may also comprise a bale loader 30 which serves to load bales onto rollers 2. Loader 30 generally comprises a plurality of arms 32 which extend outwardly from loader 30 so that they may support a bale. Feeder 1 and loader 30 maybe moved and positioned so that arms 32 extend under a bale or into the outer layer of a bale. Arms 32 are configured to pivot about pivots or hinges 34 so that arms 32 may rotate thereby raising a bale and positioning the bale on rollers 2. Arms 32 may be supported from frame 24 with loader support 36 or by some other support method. Arms 32 are caused to pivot with a pivot actuating device such as hydraulic cylinder 38 or by similar methods known in the art.

The number of rollers on each side of the V must be at least 1, however, three rollers are preferable, more or less can be used depending on the size and type of the bale and also the size and type of the rollers. The rollers must be longer than the width of the bale they are supporting, rotating and feeding and also of sufficient diameter so as not to allow the hay to become wrapped around them. The rollers must be of sufficient strength to support the bale while rotating the bale and have means to engage the outer layer of the bale to cause it to separate from the bale and thus to remove it from the bale and out onto the ground.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

We claim:

1. A bale feeder comprising:
a support frame; and
a plurality of substantially cylindrical rollers coupled to the support frame and positioned so as to form a V-shape and such that the axes of said rollers are substantially parallel one to another, said rollers having bale engagement devices thereon.

2. The feeder of claim 1 further comprising an enclosed drive mechanism to drive the plurality of substantially cylindrical rollers.

3. The feeder of claim 1 wherein each of said substantially cylindrical roller further comprises an axial shaft rotatably supported on bearings.

4. The feeder of claim 1 further comprising end supports that support said rollers and contain a bale on said rollers.

5. The feeder of claim 1 further comprising a bale loader coupled to the support frame.

6. A bale feeder comprising:
a support frame;
a plurality of substantially cylindrical rollers mounted to a top portion of the support frame and positioned so as to form a V-shape, said rollers having axes that are substantially parallel;
an end support located at each end of said rollers;
a plurality of bearings placed within said end supports to carry said rollers;
a drive mechanism, coupled to each of said end supports on a common end of said rollers, that rotates each of said rollers in the same direction; and
a plurality of bale engagement devices positioned on an outer surface of each of said rollers.

7. The feeder of claim 6 further comprising a housing to protect said drive mechanism from moisture and UV exposure.

8. The feeder of claim 6 further comprising a bale loader coupled to the support frame.

9. A bale feeder comprising:
a support frame;
a plurality of substantially cylindrical rollers mounted to a portion of the support frame positioned so as to form a V-shape, said rollers having axes that are substantially parallel to one another;
end supports at each end of said rollers;
a plurality of bearings placed in each of said end supports to carry said rollers;
a drive mechanism, coupled to said end supports located on a common side of said rollers, that rotates each of said rollers in the same direction;
a plurality of bale engagement devices affixed to a surface of each of said rollers;
a pair of loader arms extending from said support frame to engage a bale;
a pivot, coupling said pair of said loader arms to said support frame, to allow said arms to rotate upwardly thereby placing said bale on said rollers; and
a pivot actuating device to cause said loader arms to pivot.

10. The feeder of claim 9 further comprising a housing to protect said drive mechanism from moisture and UV exposure.

11. The feeder of claim 6 further comprising a bale loader coupled to the support frame.

12. The feeder according to claim 9 wherein the drive mechanism further comprises a motor.

13. The feeder according to claim 9 wherein the drive mechanism further comprises a pulley that loops around the end supports of the rollers.

14. The feeder according to claim 9 wherein the drive mechanism is gear driven.

15. The feeder according to claim 13 wherein the drive mechanism further comprises a motor and a belt coupling the motor to the pulley.

16. The feeder according to claim 9 wherein the rollers rotate a bale with generally no transverse motion of said bale.
